(19) United States
(12) Patent Application Publication
(10) Pub. No.: US 2007/0011230 A1
(43) Pub. Date: Jan. 11, 2007

(54) Method for managing selective presence for an instantaneous messaging service in a telecommunication network such as an internet network

(75) Inventors: Armelle Clech, Tregastel (FR); Frederique Pinson, Perros-Guirec (FR); Cecile Bothorel, Pleumeur Bodou (FR)

Correspondence Address: LOWE HAUPTMAN BERNER, LLP, 1700 DIAGONAL ROAD, SUITE 300, ALEXANDRIA, VA, 22314, US

(73) Assignee: France Telecom SA, Paris (FR)

(21) Appl. No.: 10/546,273

(22) PCT Filed: Feb. 16, 2004
(86) PCT No.: PCT/FR04/00351

§ 371 Date: Aug. 19, 2005

(30) Foreign Application Priority Data
Feb. 20, 2003 (FR) 03/02119

(51) Int. Cl. G06F 15/16

(52) U.S. Cl. 709/204

(57) ABSTRACT

An instant messaging service enables plural users in an address book to form a discussion group within which the users exchange messages synchronously. A presence management method enables a user to appear to be present or not on the instant messaging service from the point of view of at least one of the members of his address book. The management method includes user selecting respective presence states for one or more members or groups of members of the address book, transmitting the respective presence states to the members or groups of members and modifying the presence state relating to the user for each of the members or groups of members according to the received respective presence states.

The present invention concerns in general terms a selective presence management method for an instantaneous messaging service within a telecommunications network such as the Internet.

In a telecommunications network such as the Internet, information is available at sites distributed on the network and is accessible from any access point such as a user terminal. This information is accessible in the form of objects identified by addresses called URLs (standing for uniform resource locator). Servers are associated with sets of information within the network. Each server is adapted to deliver, at the request of a user considered to be a client, information actually contained in the set of information with which it is associated. The user terminal and the server dialogue according to a model called the client/server model, which is a computerisation model in which the processing operations are distributed between the terminal considered to be the client and the server. A client and server exchange methods in accordance with suitable protocols according to the services used and transmit these respective messages generally according to the TCP/IP protocol(Transmission Control Protocol/Internet Protocol) for the transport and network layers.

Amongst these services, the electronic mail service known by the name “E-mail” makes it possible to send and receive messages by means of an electronic mailbox associated with a messaging server. The messages intended for a user are received by the messaging server and stored in the electronic mailbox, from where they can be delivered to the user, at the request of the latter, who then acts as a client vis-à-vis the messaging server.

Amongst these services, instantaneous messaging services are also known, also known by the term “chat”. Such an instantaneous messaging service allows direct dialogue between users by means of written messages sent and received synchronously. For this a group of users each having adapted client computing means, referred to in the remainder of this description as the client unit, get in communication through the network via an instantaneous messaging server. A message sent by a client unit of a user can then immediately be consulted, via the server, by the whole of the group. The instantaneous messaging service is also adapted to list a set of persons able to be put into communication by instantaneous messaging. User identification data are listed in an entity called the address book or, in Anglophone terminology, buddy list or roster. A using wishing to engage a discussion with the contacts entered in an address book can at any time sent a request in this regard to the messaging server from the client unit of his terminal. He will then be able to send written messages which will immediately be transmitted to the other persons connected and he will receive written messages coming from these persons.

A presence management method is generally associated with an instantaneous messaging service. This is a method whose function is to determine, at a given time, whether or not a user is present on the instantaneous messaging service, that is to say whether or not he is available to participate in a discussion with the members of his address book. In order to be present on an instantaneous messaging service, a user must of course be connected to the server. When a user, by means of a client unit, sends a request to the messaging service with a view to joining in a discussion, the server will then indicate the connection of this user to the other users already connected to the instantaneous messaging server. The presence management method can also make it possible to manage the presence of a user according to presence information selected by the user. This information can indicate that a user is available, that he is ready to discuss or that he does not wish to be disturbed, that he is busy, that he is in a meeting, that he wishes to appear as being off line, etc. It can consist of a presence state proper but also of a particular presence state, in particular wording, etc. This information is sent by the server to the users connected. According to this information, the user is considered by the messaging client units of the other users as being present or not present.

In the presence management methods known at the present time, the presence information relating to a user is sent by means of a message to the instantaneous messaging server, which distributes this presence information by means of messages to all the contacts of the address book of the user. The messages in question here are messages in accordance with instantaneous messaging service protocols, such as the Jabber, ICQ, MSN, Yahoo, etc protocols allowing dialogue between instantaneous messaging servers and instantaneous messaging clients.

In these known management methods, all the members of the address book connected to the server receive the same presence information concerning the user. However, this user may experience the need to undertake a discussion with some of the members of his address book and not with others. This is not possible with the presence management methods known at the present time.

The present invention relates to a presence management method that will make it possible to overcome this problem.

To this end, it proposes a selective presence management method for an instantaneous messaging service, the said instantaneous messaging service being adapted so that a plurality of users entered in an address book constitute a discussion group within which the said users can exchange messages synchronously, the said selective management method being characterised in that it comprises:

a selection step in which a user selects, for at least one member of the address book, a respective item of presence information;

a transmission step in which each item of presence information is respectively transmitted to the said member of the said address book for which it has been selected; and

a modification step in which the said presence information relating to the said user is modified for each member of the said address book for which presence information has been respectively received.

Thus the user can manage his presence so as to appear present for some contacts and not present for others. The presence information, transmitted over the network to the contacts concerned, will be recorded for example by the instantaneous messaging client unit of each of these contacts so that, from the point of view of this contact, the user will appear to be present or not.

Advantageously, the said transmission step comprises a first transmission step in which the said respective item or items of presence information are transmitted to an instantaneous messaging server and a second transmission step in which the said respective item or items of presence information are respectively transmitted by the said server to the said member or members of the address book for which they have been selected.

According to another aspect of the present invention, in the said selection step, the said user selects, for at least one group of members of the said address book, a respective item of presence information.

Thus a user can selectively manage his presence not only by contacts but by groups of contacts. For example, when he wishes to form a discussion group with persons forming part of a first identifiable group, he sends to this group presence information making him appear to be present. If, moreover, he does not wish to be disturbed by the other members of his address book, such as, for example, friends, he sends to the latter presence information making him appear to be not present.

According to another aspect of the present invention, the said first transmission step is executed by means an instantaneous messaging client unit that comprises a terminal adapted to transmit, to the said instantaneous messaging server, presence information messages indicating presence information selected during the selection step for one of the said members or one of the said groups of members of the said address book.

In other words, each item of presence information selected by the user for a given member or a given group of members of his address book is the subject of a message sent to the server. This message is a standard message in accordance with the instantaneous messaging service protocol. Because of this, the server, when it receives this message, will in its turn transmit a message to the contact concerned or the group of contacts concerned relating to the presence state of the user in the same way as during the functioning of a conventional presence management method in which presence information is sent to all the members of the address book. Thus, by the method of the present invention, it is necessary to use a messaging client unit specifically adapted to enable the user to effect a selected presence management by group of contacts according to the invention. On the other hand, it is however not necessary to modify the instantaneous messaging service, nor the instantaneous client units of the contacts of the user. The use of the method according to the invention also does not give rise to any modification of the instantaneous messaging protocols. The messages used for the selective presence management are standard messages.

According to another aspect of the present invention, before a step of disconnection of a terminal from the said instantaneous messaging service, there is executed a storage step consisting of storing presence information for each member or group of members of the said address book for which the user of the said terminal is not present, so that, after a step of reconnection to the said instantaneous messaging service following the said disconnection step, the said instantaneous messaging client unit of the terminal transmits to the said instantaneous messaging server a presence information message or messages indicating to each member or group of members the presence information as stored during the said storage step.

In order to be able to establish the connection with the instantaneous messaging service, the instantaneous messaging client unit must, conventionally, send a connection request to the instantaneous messaging server. On reception of this request, the instantaneous messaging server sends, in accordance with the standard protocol, messages indicating the connection of the user to the messaging service to all the members of the address book including the member or groups of members to whom it was indicated that the user was not present before the disconnection. Before ensuring that the situation before disconnection is re-established, messages are immediately sent after the connection request indicating that the user is not present for the member or members or groups of members from the point of view of whom the user was not present before the disconnection. Before executing the said storage step, the said instantaneous messaging client unit of the said user can be provided with storage means adapted to store the list of contacts selected for which the user was not present during the preceding session. Alternatively such a storage means can be located on the instantaneous messaging server, the list of contacts selected for whom the user was not present during the previous session being transmitted to the instantaneous messaging client after connection.

The instantaneous messaging server involved in the above is the server on which the user wishing to control his presence depends. The instantaneous messaging service can of course use several servers between which the messages are transmitted, the various users depending on one or other server. This does not interfere with the functioning of the method according to the invention since the latter does not give rise to any modification of the instantaneous messaging protocols. The conventional mechanism for routing between servers can thus be used.

The present information also concerns an instantaneous messaging client unit intended to be implemented in a terminal and to exchange messages with an instantaneous messaging server.

According to the present invention, this client unit is designed to be able to transmit presence information messages indicating presence information for the user of the said terminal vis-à-vis a member or group of members of the address book related to the instantaneous messaging.

According to another characteristic of the invention it comprises storage means able to store, for each member or group of members of the said address book, associated presence information.

According to another characteristic of the invention, it comprises processing means for specifically processing the messages come from members, such as a blockage, sorting, delay, display, etc, and means for associating at least one specific processing with the messages coming from a member of the address book related to the said messaging according to the presence information of the said member.

The present invention also concerns an instantaneous messaging server able to deliver instantaneous messaging services to terminals that have access thereto. It comprises storage means able to store, in relation to a terminal, presence information on each member or group of members of the address book related to the said messaging for which the user of the said terminal is not present at the time of disconnection of the said terminal and to transmit to the said terminal, at the time of reconnection of the said terminal, the presence information on each member or group of members as stored at the time of the disconnection of the said terminal.

Finally, the present invention concerns a terminal with means necessary for the use of the instantaneous messaging services of an instantaneous messaging server. It is also provided with the means necessary for implementing the management method that is described above.

The characteristics of the invention mentioned above, as well as others, will emerge more clearly from a reading of the following description of an example embodiment, the said description being given in relation to the accompanying Figs amongst which:

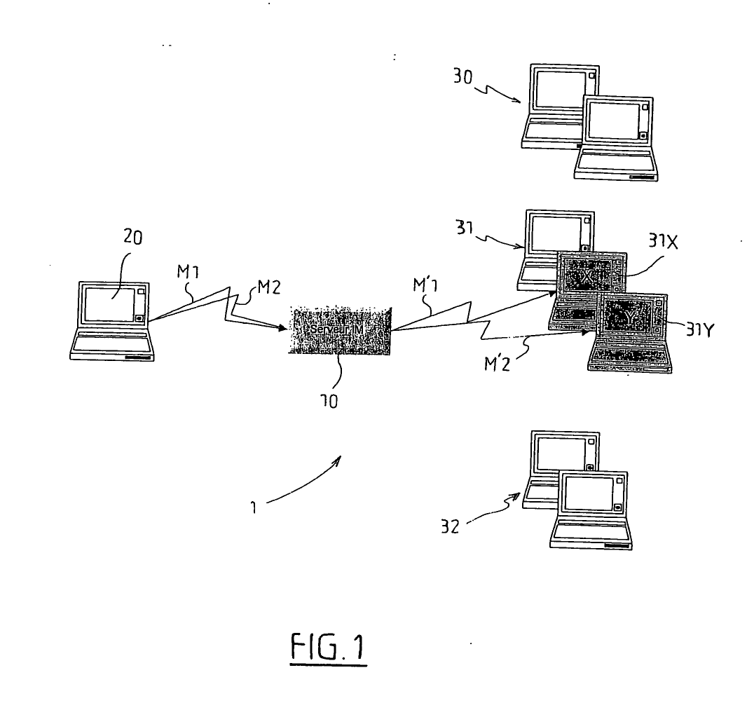

FIG. 1 is a diagram showing the messages transmitted by the various elements of an instantaneous messaging system for a first presence management operation executed by means of a selective presence management method according to the invention; and

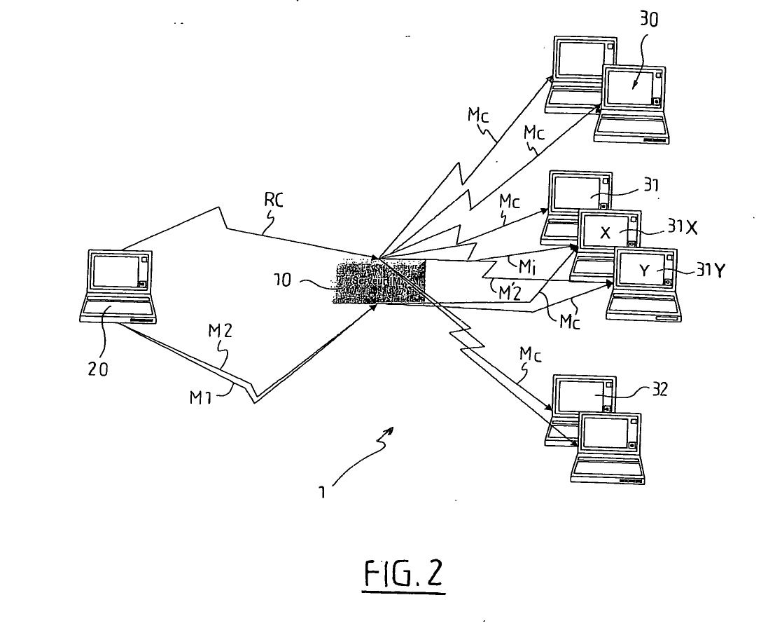

FIG. 2 is a diagram showing the messages transmitted by the various elements of an instantaneous messaging system for a second presence management operation executed by means of a selective presence management method according to the invention.

A selective presence management method according to one example embodiment of the present invention applies to an instantaneous messaging service.

With reference to FIGS. 1 and 2, an instantaneous messaging system 1 comprises an instantaneous messaging server 10 to which user terminals, then considered to be clients, can connect at their request. The messages between server and clients are exchanged for example via the Internet. This system is an instantaneous messaging system of a known type using a standard message exchange protocol.

A user for the benefit of whom the selective presence management method according to the invention is applied has a user terminal 20 with which there is associated an instantaneous messaging client unit adapted to the application of the selective presence management method according to the invention. The address book of this user contains a certain number of contacts separated into a certain number of groups, for example three in this case: a first group 30, a second group 31 and a third group 32. Each of these contacts has a user terminal with which there is associated a instantaneous messaging client unit, which may be of the standard type (the corresponding user then does not completely benefit from the advantages of the present invention) but also of the same type as the terminal 20.

FIG. 1 shows the messages transmitted by the various elements of the instantaneous messaging service 1 for a presence management operation aimed at showing the user of the terminal 20 as not being present for two contacts 31X and 31Y of the second group of contacts 31, whilst this user is moreover connected to the server 10.

During a first selection step, the user selects, by means of an adapted user interface, the contacts in his address book for which he wishes to appear as not being present on the instantaneous messaging service (in this case the contacts 31X and 31Y). The user interface can for example take the form of a contextual menu appearing on the screen of the terminal 20 and listing all the contacts of the address book collected together by groups. With each of the contacts, the messaging client unit associates a presence parameter that the user can fix. This presence parameter concerns the presence state of the terminal 20 vis-à-vis the other contacts of the messaging. This information can indicate that the user of the terminal 20 is available, that he is ready to discuss or that he does not wish to be disturbed, that he is busy, that he is in a meeting, that he wishes to appear as being off line, etc. The user can therefore select, by means of this user interface, a contact or a group of contacts in order to associate therewith given presence information.

Once the contacts for which the user wishes to appear as not being present have been selected, as many messages as there are contacts selected (here two, M1 and M2) are successively sent to the instantaneous messaging server 10 by the instantaneous messaging client unit of the terminal 20. Each of these messages is a standard message, in accordance of the protocol of the instantaneous messaging system 1, indicating that the user is not present. However, and unlike the standard, in the header area intended to identify the address book, the messaging client unit does not place, for each of these messages, all the contacts of the messaging but only the identification data of the respective contacts 31X and 31Y for which the user 20 wishes to appear as not being present. This or these messages M1, M2 are subsequently referred to as the presence information message. The server 10, when it receives an absence message M1, M2, will in its turn transmit a corresponding message M′1, M′2 solely to the contact referred to in the header of the corresponding presence information message M1, M2, as it would in the context of a conventional presence management method when the address book contains only one contact.

After the step of transmitting presence information to the contacts 31X and 31Y, there is executed, conventionally, a step of modifying the presence information concerning the user of the terminal 20 in the respective client units of these contacts 31X and 31Y.

In this way, the client units of these contact 31X and 31Y will see the user of the terminal 20 as not being present on the instantaneous messaging service.

The functioning would be similar in the case where the user has selected one or more groups of contacts in their entirety, a presence information message is sent to each contact of the group or groups selected.

FIG. 2 shows the messages transmitted by the various elements of the instantaneous messaging system 1 for a presence management operation taking place after a disconnection and then reconnection and aimed at re-establishing the situation existing before the said disconnection. In this example, the situation to be re-established is that which was obtained just after the management operation that has just been described with reference to FIG. 1.

In order to be able to re-establish the connection with the instantaneous messaging service, the instantaneous messaging client unit of the terminal 20 must, conventionally, send a connection request RC to the instantaneous messaging server 10. On reception of this request RC, the instantaneous messaging server 10 sends to all members of the address book, in accordance with the standard protocol, messages Mc indicating connection of the user of the terminal 20 to the messaging service. Thus the instantaneous messaging client units of the members of the address book consider the user of the terminal 20 as being present for the messaging service.

In order to re-establish the situation before disconnection, the instantaneous messaging client unit of the terminal 20 is adapted to execute once again the transmission step described with reference to FIG. 1, so as to transmit the presence information messages M1 and M2 and to have the server 10 send the corresponding messages M′1 and M′2 to the contacts 31X and 31Y.

It is necessary for this purpose for the presence information corresponding to each of the contacts to be stored by the client unit of the terminal 1 before disconnection. For this purpose, the instantaneous messaging client unit of the terminal 20 is provided with a storage means able to store the list of contacts selected for which the user was not present during the previous session. Alternatively, such a storage means can be located on the instantaneous messaging server 10, the list of selected contacts for whom the user was not present during the previous session being transmitted to the terminal 20 after connection.

1-9. (canceled)

10. Selective presence management method for an instantaneous messaging service, the instantaneous messaging service being performed so that a plurality of users entered in an address book comprise a discussion group within which the users can exchange messages synchronously, the selective management method comprising:
a user selecting, for at least one member of the address book, a respective item of presence information;
respectively transmitting each item of presence information to the selected member of the address book; and
modifying the presence information relating to the user for each member of the address book for which presence information has been received.

11. Method according to claim 10, wherein the transmission step comprises a first transmission step during which the respective item or items of presence information are transmitted to an instant messaging server and a second transmission step during which the respective item or items of presence information are respectively transmitted by the server to the member or members of the selected address book.

12. Method according to claim 11, wherein during the selection step the user selects, for at least one group of members of the address book, a respective item of presence information.

13. Method according to claim 10, wherein during the selection step the user selects, for at least one group of members of the address book, a respective item of presence information.

14. Method according to claim 11, wherein the first transmission step is executed by using an instant messaging client unit that comprises a terminal that transmits, to an instant message server, presence information messages indicating presence information selected during the selection step for one of the members or one of the groups of members of the address book.

15. Method according to claim 12, wherein the first transmission step is executed by using an instant messaging client unit that comprises a terminal that transmits, to an instant message server, presence information messages indicating presence information selected during the selection step for one of the members or one of the groups of members of the address book.

16. Method according to claim 14, further including performing a storage step before a terminal is disconnected from the instant messaging service, the storage step including: storing presence information for each member or group of members that is associated with a member or groups of members; reconnecting the instantaneous messaging service following the disconnection; after the reconnecting step following the disconnection, transmitting from the instantaneous messaging client unit of the terminal to the instantaneous messaging server a presence information message or messages that is sent to each member of group of members to indicate to each member or group of members the presence information stored during the storage step.

17. Method according to claim 15, further including performing a storage step before a terminal is disconnected from the instant messaging service, the storage step including: storing presence information for each member or group of members that is associated with a member or groups of members; reconnecting the instantaneous messaging service following the disconnection; after the reconnecting step following the disconnection, transmitting from the instantaneous messaging client unit of the terminal to the instantaneous messaging server a presence information message or messages that is sent to each member of group of members to indicate to each member or group of members the presence information stored during the storage step.

18. Instantaneous messaging client unit adapted to be installed in a terminal and to exchange messages with an instant messaging server, the client unit including a transmitting arrangement for transmitting presence information messages indicating presence information about the user of the terminal vis-à-vis a member or a group of members of an address book related to the instant messaging, and a storage arrangement for storing for each member or group of members of the address book, presence information associated with the member or group of members.

19. Client unit according to claim 17, comprising a processor arrangement for specifically processing messages coming from the members and for associating at least one process specific to the messages coming from a member of the address book related to the messaging according to the presence information of the member.

20. Method according to claim 10, further including performing a storage step before a terminal is disconnected from the instant messaging service, storing presence information for each member or group of members of the address book for which the user of the terminal is not present; after reconnection to the instant messaging service following the disconnection step, the instant messaging client unit of the terminal transmits to the instant messaging server a presence information message or messages indicating to each member or group of members the presence information as stored during the storage step.

21. A terminal for use with the instantaneous messaging services of an instantaneous messaging server, the terminal being arranged for performing the management method of claim 10.

22. A terminal for use with the instantaneous messaging services of an instantaneous messaging server, the terminal being arranged for performing the management method of claim 11.

23. A terminal for use with the instantaneous messaging services of an instantaneous messaging server, the terminal being arranged for performing the management method of claim 12.

24. A terminal for use with the instantaneous messaging services of an instantaneous messaging server, the terminal being arranged for performing the management method of claim 13.

25. A terminal for use with the instantaneous messaging services of an instantaneous messaging server, the terminal being arranged for performing the management method of claim 14.

26. A terminal for use with the instantaneous messaging services of an instantaneous messaging server, the terminal being arranged for performing the management method of claim 15.

27. A terminal for use with the instantaneous messaging services of an instantaneous messaging server, the terminal being arranged for performing the management method of claim 16.

28. A terminal for use with the instantaneous messaging services of an instantaneous messaging server, the terminal being arranged for performing the management method of claim 17.
